(19) United States
(12) Patent Application Publication
(10) Pub. No.: US 2024/0233088 A9
(43) Pub. Date: Jul. 11, 2024

(54) VIDEO GENERATION METHOD AND APPARATUS, DEVICE AND MEDIUM

(71) Applicant: Lemon Inc., Grand Cayman (KY)

(72) Inventors: Yi MO, Beijing (CN); Michel JONES, Tokyo (JP); Congxiao LIU, Beijing (CN); Jing GAO, Beijing (CN)

(21) Appl. No.: 18/543,969

(22) Filed: Dec. 18, 2023

Related U.S. Application Data
(63) Continuation of application No. PCT/SG2022/050293, filed on May 10, 2022.

(30) Foreign Application Priority Data
Jun. 24, 2021 (CN) 202110704110.6

(51) Int. Cl. G06T 5/50; G06T 7/194; G06V 10/46

(52) U.S. Cl. CPC G06T 5/50; G06T 7/194; G06V 10/46; G06T 2207/20132; G06T 2207/20221

(57) ABSTRACT

The present disclosure provides a video generation method, an apparatus, a device and a medium, and the method includes: acquiring background images; acquiring an image to be segmented comprising a target object; performing image segmentation for the target object on the image to be segmented to obtain a contour image corresponding to the target object; using the contour image as a foreground image of a target display video; and cyclically flipping the background images, and generating the target display video by fusing the foreground image and the background images, in which the background images are being cyclically flipped in the target display video.

### CROSS-REFERENCE TO RELATED APPLICATION

This application is a continuation of International Application No. PCT/SG2022/050293 filed on May 10, 2022, which claims the priority to and benefits of Chinese Patent Application No. 202110704110.6, filed on Jun. 24, 2021. All the aforementioned patent applications are hereby incorporated by reference in their entireties.

### TECHNICAL FIELD

The present disclosure relates to a field of video processing technology, more particularly, to a video generation method, an apparatus, a device and a medium.

### BACKGROUND

With the development of video processing technology, common videos are no longer able to meet people's demands for content acquisition. Videos that are full of novelty and unique gameplay have gradually attracted people's attention. At present, when users are shooting videos, the videos usually can only display the real scene the users are currently in, which greatly limits the special effects and gameplay of the videos and cannot meet the user's pursuit of fun in the videos.

### SUMMARY

In order to solve the above-mentioned technical problems or at least partially solve the above-mentioned technical problems, the present disclosure provides a video generation method, an apparatus, a device, and a medium.

The present disclosure provides a video generation method, and the method comprises:
acquiring background images;
acquiring an image to be segmented comprising a target object;
performing image segmentation for the target object on the image to be segmented to obtain a contour image corresponding to the target object;
using the contour image as a foreground image of a target display video;
and cyclically flipping the background images, and generating the target display video by fusing the foreground image and the background images, in which the background images are being cyclically flipped in the target display video.

Optionally, acquiring the background images comprises:
acquiring at least one first image input by a user;
acquiring a second image captured at a current moment in real time;
using the at least one first image and the second image as the background image; and
cyclically flipping the background images comprises:
cyclically flipping and switching the at least one first image and the second image.

Optionally, acquiring the image to be segmented comprising the target object, comprises:
determining an image comprising the target object in the first image and/or the second image as the image to be segmented.

Optionally, cyclically flipping the background images comprises:
cyclically flipping the background images according to a manner of horizontal flipping or vertical flipping with a centerline of the target object as a flipping axis.

Optionally, using the contour image as the foreground image of the target display video comprises:
determining a position of the contour image in the image to be segmented and replacing a region image on the target display video corresponding to the position with the contour image;
or overlaying the contour image as a foreground image on the target display video.

Optionally, in a case where the image to be segmented is an image comprising a plurality of target objects, the method further comprises:
dividing contour images of the plurality of target objects on the image to be segmented into at least one target object image combination.

Optionally, in a case where there are a plurality of target object image combinations, the method further comprises:
whenever the background images are flipped and switched, switching corresponding target object image combinations.

Optionally, cyclically flipping and switching the background images comprises:
using the second image as a starting frame image for cyclically flipping and switching the background images, and starting from the starting frame image, displaying corresponding background images that are sequentially flipped and switched by a display order that is pre set; in which the display order comprises an input order of the first image, an order of a total number of the target objects, and/or a spatial arrangement order of the target objects on the second image.

Optionally, performing image segmentation of the target object on the image to be segmented comprises:
determining an area proportion of the target object on the image to be segmented;
in a case where the area proportion is less than a preset first proportion, clipping a candidate image from the image to be segmented, so that a position and an area proportion of the target object on the candidate image meet preset conditions;
and performing image segmentation for the target object on the candidate image.

Optionally, the method further comprising:
during a process of cyclically flipping the background images, always displaying the contour image in a way that penetrates the background images.

Optionally, a manner of the flipping comprises vertical flipping with a horizontal centerline of a video shooting interface as a flipping axis, horizontal flipping with a vertical centerline of the video shooting interface as a flipping axis, and/or circular flipping with a center point of the video shooting interface as a rotation center.

Optionally, the method further comprising:
during a process of cyclically flipping the background images, the second image and the first image undergo deformation corresponding to a manner of the flipping.

Optionally, a manner of the flipping comprises an erasing switching manner, a transparency change switching manner, or a dissolution switching manner.

Optionally, the second image is acquired according to a preset time interval and the preset time interval is related to a period of cyclic flipping and switching.

The present disclosure further provides a video generation apparatus, and the apparatus comprises:
a first acquisition module configured to acquire background images;
a second acquisition module configured to acquire an image to be segmented comprising a target object;
an image segmentation module configured to perform image segmentation for the target object on the image to be segmented to obtain a contour image corresponding to the target object;
and a video generation module configured to use the contour image as a foreground image of a target display video, and further configured to cyclically flip the background images and generate the target display video by fusing the foreground image and the background images, wherein the background images are being cyclically flipped in the target display video.

The present disclosure further provides an electronic device, and the electronic device comprises: a processor; and a memory for storing executable instructions of the processor; and the processor is configured to read the executable instructions from the memory and execute the executable instructions to implement the video generation method provided by any one of the embodiments of the present disclosure.

The present disclosure further provides a computer-readable storage medium storing a computer program, and the computer program, when executed by a computer device, causes the computer device to implement the video generation method provided by any one of the embodiments of the present disclosure.

The technical solution provided by the embodiments of the present disclosure has the following advantages:

The embodiments of the present disclosure provide a video generation method, an apparatus, a device and a medium, and the method comprises: first, acquiring background images; acquiring an image to be segmented comprising a target object; then performing image segmentation for the target object on the image to be segmented to obtain a contour image corresponding to the target object; finally, using the contour image as a foreground image of a target display video, and cyclically flipping the background images and generating the target display video by fusing the foreground image and the background images, in which the background images are being cyclically flipped in the target display video.

Through the above solution, users can seamlessly blend the target object with the background images according to their requirements while shooting videos in their daily lives. In addition, by cyclically flipping the background images, it brings users a special effect gameplay of dynamic scene changes, allowing users to immerse themselves in the scene and increases the fun of video shooting.

### BRIEF DESCRIPTION OF DRAWINGS

The drawings are used to provide a further understanding of the present disclosure, form a part of the present disclosure, are used in conjunction with the embodiments of the present disclosure to explain the present disclosure and do not constitute a limitation of the present disclosure. In the drawings:

FIG. 1 is a schematic flowchart of a video generation method provided by the embodiments of the present disclosure;

FIG. 2 is a schematic diagram of a flipping process of a background image provided by the embodiments of the present disclosure;

FIG. 3 is a schematic diagram of a penetration effect provided by the embodiments of the present disclosure;

FIG. 4 is a schematic diagram of a structure of a video generation apparatus provided by the embodiments of the present disclosure; and

FIG. 5 is a schematic diagram of a structure of an electronic device provided by the embodiments of the present disclosure.

### DETAILED DESCRIPTION

In order to better understand the above objectives, features, and advantages of the present disclosure, the embodiments of the present disclosure will be further described below. It should be noted that in the absence of conflict, the embodiments of the present disclosure and the features in the embodiments can be combined with each other.

Many specific details are set forth in the following description to facilitate a full understanding of the present disclosure, but the present disclosure can also be implemented in other ways different from those described here. Obviously, the embodiments in the specification are only a part of the embodiments of the present disclosure, rather than all of them.

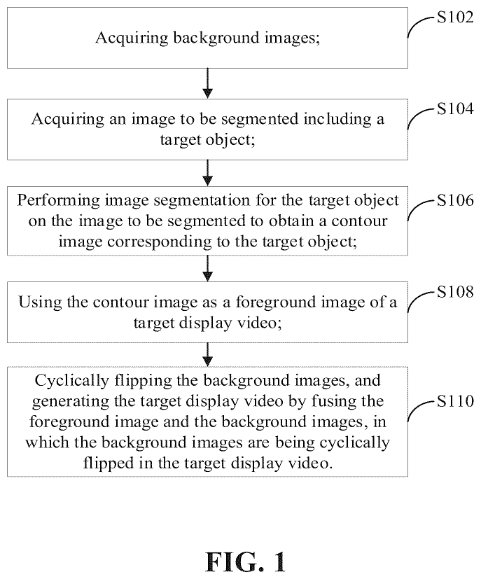

FIG. 1 is a schematic flowchart of a video generation method provided by the embodiments of the present disclosure, which can be executed by a video generation apparatus. The apparatus can be implemented by using software and/or hardware, and generally integrated into an electronic device. As shown in FIG. 1, the video generation method includes:

Step 102: acquiring background images.

In practice, the user may currently be in the process of shooting a video. Acquiring background images in this embodiment may include:
acquiring at least one first image input by the user; acquiring a second image captured at the current moment in real time; and using the at least one first image and the second image as the background images. The first image is an image input by the user according to personal preferences and needs, which can meet the pursuit of scene fun when shooting videos. The second image is an image obtained in real time during the video shooting process in a real scene.

Step 104: acquiring an image to be segmented including a target object. The target object is an object such as a human body, a human face, an animal, or a vehicle. The target object included in the image to be segmented may be one or more. The present embodiment may identify an image including the target object in the first image and/or the second image as the image to be segmented.

Step 106: performing image segmentation for the target object on the image to be segmented to obtain a contour image corresponding to the target object.

In the present embodiment, the key points of the contour of the target object in the image to be segmented are firstly detected, and the contour region of the target object is determined according to the key points of the contour. Then, the contour region is clipped from the image to be segmented to obtain the contour image corresponding to the target object.

Step 108: using the contour image as a foreground image of a target display video.

There are various ways of using the contour image as the foreground image. For example, determining a position of the contour image in the image to be segmented; and replacing a region image on the target display video corresponding to the position with the contour image. In a specific implementation, individual pixel values of the region image on the target display video corresponding to the above-mentioned position may be replaced with the corresponding individual pixel values on the contour image. Thus, the contour image is displayed as the foreground image of the target display video on a display interface of the target display video.

Alternatively, similar to the above-mentioned method, it is possible to determine a first region image other than the contour image on the image to be segmented, and determine a second region image on the target display video at the same position as the first region image. Then, the first region image on the image to be segmented is replaced with the second region image, thereby using the contour image as the foreground image of the target display video.

Alternatively, in another implementation, the contour image may be directly overlaid as a foreground image on the target display video.

Step 110: cyclically flipping the background images, and generating the target display video by fusing the foreground image and the background images, in which the background images are being cyclically flipped in the target display video.

The background images include at least one first image and the second image. Based on this, cyclically flipping the background images may include: cyclically flipping and switching the at least one first image and the second image.

Because the second image is an image in a real scene, the second image is usually used as a starting frame image for cyclic flipping during the process of flipping and switching the background images. The first image is thus started to be flipped and switched, thereby realizing dynamic changes in the background images. The manner in which the first image and the second image are cyclically flipped and switched may be, but is not limited to: cyclically flipping the background images according to a manner of horizontal flipping or vertical flipping with the centerline of the target object as a flipping axis. Specifically, when the horizontal centerline of the target object is used as the flipping axis, it corresponds to the vertical flipping. When the vertical centerline of the target object is used as the flipping axis, it corresponds to the horizontal flipping.

Based on the aforementioned foreground image and the cyclically flipped background image, a target display video may be generated, i.e., the target display video displays a content including: displaying the first image and second image that are cyclically flipped and s witched in a background region, and displaying the contour image as the foreground image in a foreground region.

The video generation method provided by the embodiments of the present disclosure obtains a contour image corresponding to a target object based on an image to be segmented, and uses the contour image as a foreground image of the target display video. The background images of the obtained target display video are cyclically flipped, and the target display video is generated by combining the foreground image. With the above-mentioned solution, the user can seamlessly blend the target object with the background images according to their requirements while shooting videos in their daily lives. In addition, by cyclically flipping the background images, it brings users a special effect gameplay of dynamic scene changes, allowing users to immerse themselves in the scene and increases the fun of video shooting.

Considering that in actual shooting, the target object may appear as a very small target on the image to be segmented, or may be in an extremely biased spatial position on the image to be segmented, due to the shooting distance being too far or the shooting angle being too biased. In this case, the contour image obtained through image segmentation may be unclear. In response to this, the present embodiment provides an implementation method of image segmentation for the target object in the image to be segmented, as described below.

An area proportion of the target object on the image to be segmented is determined. In the case where the area proportion is less than a preset first proportion, a candidate image is clipped from the image to be segmented, so that the position and area proportion of the target object on the candidate image meet preset conditions. Then, image segmentation for the target object is performed on the candidate image to obtain the contour image of the target object.

The above-mentioned preset conditions may specifically include: the area proportion of the target object on the candidate image is higher than a preset second proportion, such as higher than 30%, and the position of the target object on the candidate image is within a preset deviation distance on both sides of the vertical centerline of the candidate image. When the above-mentioned preset conditions are met, the target object can occupy a suitable spatial position on the candidate image, and has strong visual expression on the video shooting interface. The contour image obtained from this can be clear, complete, and of appropriate size.

After obtaining the contour image through image segmentation, the contour image is used as the foreground image of the target display video. In addition, the background images are cyclically flipped and combined with the foreground image to generate the target display video.

This embodiment provides several methods for cyclically flipping the background images, as described below.

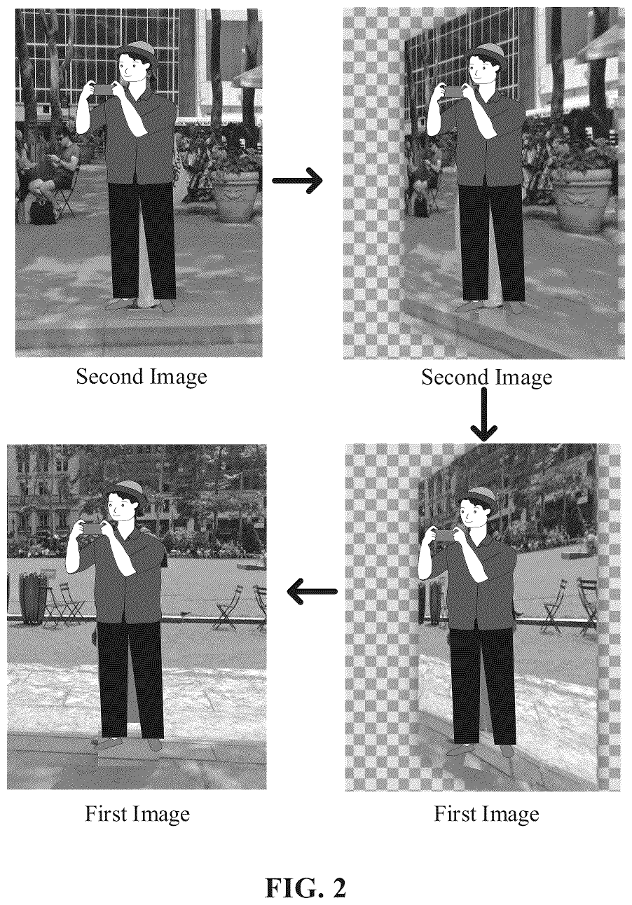

Implementation 1, in the case where there is one first image and one second image, a preset flipping and switching method is used to flip and switch from the second image to the first image. As shown in FIG. 2, a flipping method using the human body as the flipping axis is provided, specifically a method in which the image is flipped with the longitudinal vertical centerline of the human body as the axis, and the display background images are flipped perpendicular to the screen. Starting from the second image during the video shooting process, the second image is flipped horizontally until the second image is flipped 90 degrees perpendicular to the screen. Then, starting from this 90-degree angle, the first image undergoes the same horizontal flipping until it completes a full rotation to the starting position of the first image. Then, switch back to the second image and continue flipping to complete one flipping and switching, and so on.

It can be understood that as the video shooting proceeds, the above-mentioned animation of the flipping and switching is executed cyclically. The frequency of the flipping and switching may be preset, such as completing the flipping and switching in 0.7 seconds; and/or, after each flipping and switching is completed, the display duration of the first image and the second image as background images may also be preset, such as 1 second. Specifically, for example, when the second image captured in real time is displayed as the background image and reaches a preset first duration, within a preset second duration, the second image is flipped to the first image with the preset flipping and switching method, and the first image is displayed as the background image and reaches a preset third duration. The third duration may be the same as or different from the first duration. As the video is shot, the animation of the flipping and switching of the background images described above is looped.

Implementation 2: when the first image is multiple, the background images may be flipped and switched cyclically as follows.

The second image is used as the starting frame image for cyclic flipping, and from the starting frame image, the corresponding background images that are sequentially flipped and switched are displayed in accordance with a preset display order. The display order includes the input order of the at least one first image.

In a specific example, it is assumed that the input first image sequentially includes image A, image B, and image C. Then, starting from the second image obtained in real time during the video shooting process, a flipping and switching animation is displayed for flipping and switching from the second image to image A, flipping and switching from image A to image B, flipping and switching from image B to image C, and flipping and switching from image C to the second image.

Implementation 3: when the image to be segmented is an image that includes a plurality of target objects, this embodiment first divides the contour image of the plurality of target objects on the image to be segmented into at least one target object image combination. Each target object image combination may include at least one contour image of the target object. The method of cyclically flipping the background images may be as follows: the second image obtained in real time during the video shooting process is used as the starting frame image for cyclic flipping and switching. Starting from the starting frame image, corresponding background images that are sequentially flipped and switched are displayed in accordance with a preset display order, and whenever the background images are flipped, the corresponding target object image combination is switched. The display order includes an input order of the first image, an order of the total number of the target objects, and/or a spatial arrangement order of the target objects on the image to be segmented.

In a specific example, it is assumed that in a video shooting scene in which five human bodies are the target objects, the second image is an image that includes five target objects. Accordingly, target object image combination (referred to as combination) A includes a contour image of human body 1, combination B includes contour images of human body 2 and human body 3, and combination C includes contour images of human body 4 and human body 5. There is one first image, and the display order is an order of the total number of target objects from less to more, and an order of the spatial arrangement of the target objects on the second image from left to right.

In this case, when the second image is acquired in real time by video shooting and the second image is displayed as a background image, all target objects on a second image P1 are currently displayed. Starting from the second image P1, the display is flipped and switched from the second image P1 to the first image. At the same time, all the target objects displayed on the previous background image are switched to combination A, that is, in the target display video with the first image as the background image, the foreground image is the contour image of human body 1.

Next, the display is flipped and switched from the first image to a second image P2 acquired in real time. At the same time, the combination A displayed on the previous background image is switched to the combination B or the combination C. Based on the same number of target objects corresponding to the combination B and the combination C, the switching order of the combinations may be determined in conjunction with the spatial arrangement order of the target objects on the second image. In this example, the combination A displayed on the previous background image may be switched to the combination B, that is, in the target display video with the second image P2 as the background image, the foreground image is contour images corresponding to the human body 2 and the human body 3.

Next, the display is flipped and switched from the second image P2 to the first image. At the same time, the combination B displayed on the previous background image is switched to the combination C, that is, in the target display video with the first image as the background image, the foreground image is contour images corresponding to the human body 4 and the human body 5.

In the above-mentioned various implementations, the second image is an image of the current moment acquired in real time as the video is captured. Based on this, the second image may be acquired according to a preset time interval, which is related to a period of cyclic flipping and switching. For this period, in the above-mentioned implementation 1, the period is determined to include a duration of the flipping and switching from the second image to the first image and a preset duration of the first image being continuously displayed as the background image. In the above-mentioned implementation 2, the period is determined to include a duration of sequential flipping and switching from the second image to each first image and a preset duration of the last displayed first image being continuously displayed as the background image. In the above-mentioned implementation 3, the period is determined to include a duration in which flipping and switching starts from the second image with all target objects in the foreground, and the combination is switched at the same time whenever the second image and the first image is cyclically flipped and switched, until the combination is switched to the last combination, and a preset duration of the corresponding background image being continuously displayed.

It should be understood that the above are only a few exemplary descriptions of cyclically flipping the background images. In practice, there may be more embodiments of flipping and switching, which should not be understood as a limitation.

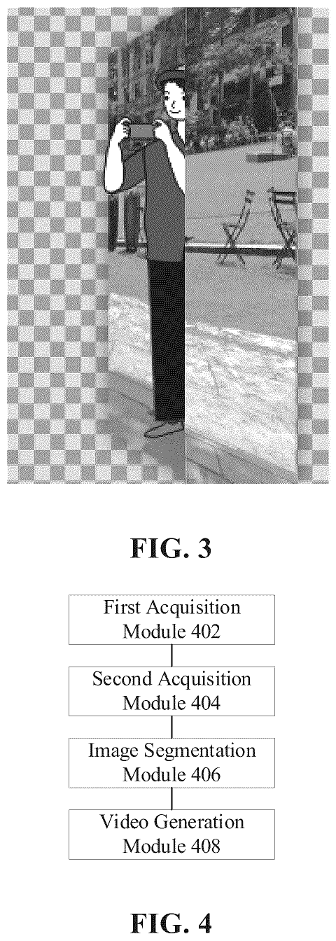

In any of the above-mentioned processes of cyclically flipping the background images, as shown in FIG. 3, the contour image is always displayed in a way that penetrates the background images. By displaying the contour image in a way that penetrates the background images, the contour image presents a three-dimensional effect, which can enhance the interesting experience of the interaction between the target object and the background images which are flipped and switched.

In the above process of cyclically flipping the background images, the manner of the flipping may also include: vertical flipping with a horizontal centerline of a video shooting interface as a flipping axis, horizontal flipping with a vertical centerline of the video shooting interface as a flipping axis, and/or circular flipping with a center point of the video shooting interface as a rotation center. Accordingly, during the process of cyclically flipping the background images, the second image and the first image undergo a deformation corresponding to the manner of the flipping. The deformation may be shown with reference to FIG. 2.

In addition, in other implementations, the manner of the flipping and switching may also be, but is not limited to, an erasing switching manner, a transparency change switching manner, or a dissolution switching manner.

In summary, the video generation method provided by the above-mentioned disclosed embodiments can seamlessly blend the target object with the background images according to their requirements while shooting videos in user's daily lives. In addition, by cyclically flipping the background images, it brings users a special effect gameplay of dynamic scene changes, allowing users to immerse themselves in the scene. And during the process of cyclically flipping the background images, by switching between the first image input by the user and the second image captured in real time, the first image and the second image are used as different background images for flipping and switching, creating a special effect gameplay of scene switching or scene traversing for users, which significantly increases the fun of video shooting.

FIG. 4 is a schematic diagram of a structure of a video generation apparatus provided by the embodiments of the present disclosure. This apparatus may be implemented by software and/or hardware, and generally integrated into an electronic device. Interesting videos with a background that may be cyclically flipped can be generated by performing the video generation method. As shown in FIG. 4, the video generation apparatus includes:
a first acquisition module 402 which is configured to acquire background images;
a second acquisition module 404 which is configured to acquire an image to be segmented including a target object;
an image segmentation module 406 which is configured to perform image segmentation for the target object on the image to be segmented to obtain a contour image corresponding to the target object;
and a video generation module 408 which is configured to use the contour image as a foreground image of a target display video, and further to cyclically flip the background images and generate the target display video by fusing the foreground image and the background images, in which the background images are being cyclically flipped in the target display video.

In some embodiments, the first acquisition module 402 includes:
an image input unit which is configured to acquire at least one first image input by a user;
an image capturing unit which is configured to acquire a second image captured at the current time in real time;
and a background determination unit which is configured to use the at least one first image and the second image as the background images.

Accordingly, the above-mentioned video generation module 408 is configured to cyclically flip and switch the at least one first image and the second image.

In some embodiments, the second acquisition module 404 is configured to determine an image including the target object in the first image and/or the second image as the image to be segmented.

In some embodiments, the above-mentioned video generation module 408 is configured to cyclically flip the background images according to a manner of horizontal flipping or vertical flipping with a centerline of the target object as a flipping axis.

In some embodiments, the above-mentioned video generation module 408 is configured to: determine a position of the contour image in the image to be segmented and replace a region image on the target display video corresponding to the position with the contour image; or overlay the contour image as a foreground image on the target display video.

In some embodiments, in the case where the image to be segmented is an image including a plurality of target objects, the video generation apparatus further includes:
a combination division module which is configured to divide contour images of the plurality of target objects on the image to be segmented into at least one target object image combination.

In some embodiments, in the case where there are a plurality of target object image combinations, the video generation apparatus further includes:
a combination switching module which is configured to switch the corresponding target object image combinations whenever the background images are flipped.

In some embodiments, the above-mentioned video generation module 408 is further configured to: use the second image as a starting frame image for cyclic flipping, and starting from the starting frame image, display corresponding background images that are sequentially flipped and switched by a display order that is preset; and the display order includes: an input order of the first image, an order of a total number of the target objects, and/or the spatial arrangement order of the target objects on the second image.

In some embodiments, the image segmentation module 406 is configured to:
determine an area proportion of the target object on the image to be segmented;
in the case where the area proportion is less than a preset first proportion, clip a candidate image from the image to be segmented, so that a position and an area proportion of the target object on the candidate image meet preset conditions;
and perform image segmentation for the target object on the candidate image.

In some embodiments, the video generation apparatus further includes:
a penetration display module which is configured to always display the contour image in a way that penetrates the background images during a process of cyclically flipping the background images.

In some embodiments, the video generation apparatus further includes:
a deformation module which is configured to deform the second image and the first image in a manner corresponding to the flipping during a process of cyclically flipping the background images.

The video generation apparatus provided by the embodiments of the present disclosure can perform the video generation method provided by any embodiment of the present disclosure, and has corresponding functional modules and beneficial effects for performing the method.

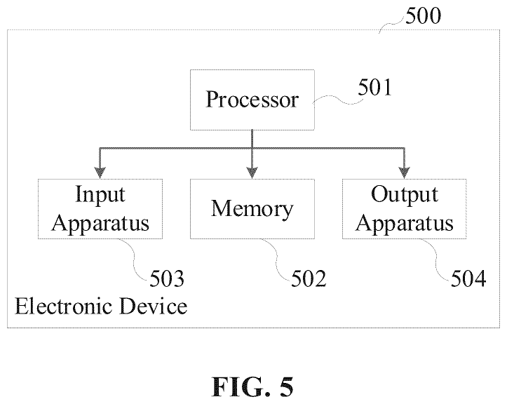

FIG. 5 is a schematic diagram of a structure of an electronic device provided by the embodiments of the present disclosure. As shown in FIG. 5, the electronic device 500 includes one or more processors 501 and a memory 502.

The processor 501 may be a central processing unit (CPU) or other form of processing unit with data processing capabilities and/or instruction execution capabilities, and may control other components in the electronic device 500 to perform desired functions.

The memory 502 may include one or more computer program products, which may include various forms of computer-readable storage media, such as volatile memory and/or non-volatile memory. The volatile memory may include, for example, a random-access memory (RAM) and/or a cache memory. The non-volatile memory may include, for example, read-only memory (ROM), hard disk, flash memory, etc. One or more computer program instructions can be stored on the computer-readable storage medium, and the processor 501 can run the program instructions to achieve the video generation method and/or other desired functions in the embodiments of the present disclosure as described above. Various contents such as input signals, signal components, noise components, etc. can also be stored in the computer-readable storage medium.

In one example, the electronic device 500 may further include an input apparatus 503 and an output apparatus 504, which are interconnected through a bus system and/or other forms of connection mechanisms (not shown).

In addition, the input apparatus 503 may include, for example, a keyboard, a mouse, and the like.

The output apparatus 504 can output various information to the outside, including determined distance information, direction information, etc. The output apparatus 504 may include, for example, a display, a speaker, a printer, a communication network, and a remote output device connected to them, etc.

Of course, for simplicity, only some of the components related to the present disclosure in the electronic device 500 are shown in FIG. 5, and the components such as bus, input/output interfaces, etc. are omitted. In addition, according to the specific application, the electronic device 500 may also include any other appropriate components.

In addition to the above methods and devices, the embodiments of the present disclosure may include a computer program product, which includes computer program instructions. The computer program instructions cause a processor to execute the video generation method described by the embodiments of the present disclosure when executed by the processor.

The computer program product may use any combination of one or more programming languages to write the program codes for performing the operations in the embodiments of the present disclosure. The programming languages include object-oriented programming languages such as Java, C++, etc., and conventional procedural programming languages such as “C” language or similar programming languages. The program codes can be completely executed on user computing devices, partially executed on user devices, executed as a standalone software package, partially executed on user computing devices and partially executed on remote computing devices, or completely executed on remote computing devices or servers.

In addition, the embodiments of the present disclosure may further include a computer-readable storage medium on which computer program instructions are stored. The computer program instructions cause a processor to execute the video generation method provided by the embodiments of the present disclosure when executed by the processor.

The computer-readable storage medium may adopt any combination of one or more readable media. The readable medium may be a readable signal medium or a readable storage medium. The readable storage medium may include, but are not limited to, systems, apparatus or devices of electricity, magnetism, light, electromagnetism, infrared, or semiconductors, or any combination of the above. More specific examples of the readable storage medium (non-exhaustive list) include: electrical connections with one or more wires, portable disks, hard disks, a random-access memory (RAM), a read-only memory (ROM), an erasable programmable read-only memory (EPROM or flash memory), an optical fiber, a portable compact disk read-only memory (CD-ROM), optical storage devices, magnetic storage devices, or any appropriate combination of the above.

The embodiments of the present disclosure further provide a computer program product, including a computer program/instructions that can implement the method in the embodiments of the present disclosure when executed by a processor.

It should be noted that in the present disclosure, relational terms such as “first,” “second,” etc. are only used to distinguish one entity or operation from another entity or operation, and do not necessarily require or imply the existence of any actual relationship or order between these entities or operations. Furthermore, the terms “comprise,” “comprising,” “include,” “including,” etc., or any other variant thereof are intended to cover non-exclusive inclusion, such that a process, method, article or device comprising a set of elements includes not only those elements, but also other elements not expressly listed, or other elements not expressly listed for the purpose of such a process, method, article or device, or elements that are inherent to such process, method, article or device. Without further limitation, an element defined by the phrase “includes a . . . ” does not preclude the existence of additional identical elements in the process, method, article or device that includes the element.

The above descriptions are only specific embodiments of the present disclosure, enabling those skilled in the art to understand or implement the present disclosure. Various modifications to these embodiments will be readily apparent to those skilled in the art, and the generic principles defined herein may be practiced in other embodiments without departing from the spirit or scope of the present disclosure. Therefore, the present disclosure is not to be limited to the embodiments described herein but is to be accorded the widest scope consistent with the principles and novel features disclosed herein.

1. A video generation method, comprising:
acquiring background images;
acquiring an image to be segmented comprising a target object;
performing image segmentation for the target object on the image to be segmented to obtain a contour image corresponding to the target object;
using the contour image as a foreground image of a target display video; and
cyclically flipping the background images, and generating the target display video by fusing the foreground image and the background images, wherein the background images are being cyclically flipped in the target display video.

2. The method according to claim 1, wherein acquiring the background images comprises:
acquiring at least one first image input by a user;
acquiring a second image captured at a current moment in real time;
using the at least one first image and the second image as the background images; and
cyclically flipping the background images comprises:
cyclically flipping and switching the at least one first image and the second image.

3. The method according to claim 2, wherein acquiring the image to be segmented comprising the target object comprises:
determining an image comprising the target object in the first image and/or the second image as the image to be segmented.

4. The method according to claim 1, wherein cyclically flipping the background images comprises:
cyclically flipping the background images according to a manner of horizontal flipping or vertical flipping with a centerline of the target object as a flipping axis.

5. The method according to claim 1, wherein using the contour image as the foreground image of the target display video comprises:
determining a position of the contour image in the image to be segmented, and replacing a region image on the target display video corresponding to the position with the contour image;
or overlaying the contour image as a foreground image on the target display video.

6. The method according to claim 2, wherein in a case where the image to be segmented is an image comprising a plurality of target objects, the method further comprises:
dividing contour images of the plurality of target objects on the image to be segmented into at least one target object image combination.

7. The method according to claim 6, wherein in a case where there are a plurality of target object image combinations, the method further comprises:
whenever the background images are flipped and switched, switching corresponding target object image combinations.

8. The method according to claim 6, wherein cyclically flipping and switching the background images comprises:
using the second image as a starting frame image for cyclically flipping and switching the background images, and starting from the starting frame image, displaying corresponding background images that are sequentially flipped and switched by a display order that is preset, wherein the display order comprises an input order of the at least one first image, an order of a total number of the target objects, and/or a spatial arrangement order of the target objects on the second image.

9. The method according to claim 1, wherein performing image segmentation of the target object on the image to be segmented comprises:
determining an area proportion of the target object on the image to be segmented;
in a case where the area proportion is less than a preset first proportion, clipping a candidate image from the image to be segmented, so that a position and an area proportion of the target object on the candidate image meet preset conditions; and
performing image segmentation for the target object on the candidate image.

10. The method according to claim 1, further comprising:
during a process of cyclically flipping the background images, always displaying the contour image in a way that penetrates the background images.

11. The method according to claim 2, wherein a manner of the flipping comprises vertical flipping with a horizontal centerline of a video shooting interface as a flipping axis, horizontal flipping with a vertical centerline of the video shooting interface as a flipping axis, and/or circular flipping with a center point of the video shooting interface as a rotation center.

12. The method according to claim 2, further comprising:
during a process of cyclically flipping the background images, the second image and the first image undergo deformation corresponding to a manner of the flipping.

13. The method according to claim 2, wherein a manner of the flipping comprises an erasing switching manner, a transparency change switching manner, or a dissolution switching manner.

14. The method according to claim 2, wherein the second image is acquired according to a preset time interval and the preset time interval is related to a period of cyclic flipping and switching.

15. A video generation apparatus, comprising:
a first acquisition module, configured to acquire background images;
a second acquisition module, configured to acquire an image to be segmented comprising a target object;
an image segmentation module, configured to perform image segmentation for the target object on the image to be segmented to obtain a contour image corresponding to the target object; and
a video generation module, configured to use the contour image as a foreground image of a target display video, and further configured to cyclically flip the background images and generate the target display video by fusing the foreground image and the background images, wherein the background images are being cyclically flipped in the target display video.

16. An electronic device, comprising:
a processor; and
a memory for storing executable instructions of the processor,
wherein the processor is configured to read the executable instructions from the memory and execute the executable instructions to implement the video generation method according to claim 1.

17. An electronic device, comprising:
a processor; and
a memory for storing executable instructions of the processor,
wherein the processor is configured to read the executable instructions from the memory and execute the executable instructions to implement the video generation method according to claim 2.

18. An electronic device, comprising:
a processor; and
a memory for storing executable instructions of the processor,
wherein the processor is configured to read the executable instructions from the memory and execute the executable instructions to implement the video generation method according to claim 3.

19. An electronic device, comprising:
a processor; and
a memory for storing executable instructions of the processor,
wherein the processor is configured to read the executable instructions from the memory and execute the executable instructions to implement the video generation method according to claim 4.

20. A computer-readable storage medium, storing a computer program, wherein the computer program, when executed by a computer device, causes the computer device to implement the video generation method according to claim 1.
